(19) United States
(12) Patent Application Publication
(10) Pub. No.: US 2004/0208525 A1
(43) Pub. Date: Oct. 21, 2004

(54) SRS-immune optical performance monitoring

(75) Inventors: Saeid Seydnejad, Ottawa (CA); Frederic F. Simard, Nepean (CA); Yunjun Zhang, Ottawa (CA)

Correspondence Address: OGILVY RENAULT, 1981 MCGILL COLLEGE AVENUE, SUITE 1600, MONTREAL, QC, H3A2Y3, CA

(73) Assignee: NORTEL NETWORKS LIMITED, St. Laurent (CA)

(21) Appl. No.: 10/057,896

(22) Filed: Jan. 29, 2002

(51) Int. Cl. H04B 10/08; H04J 14/02

(52) U.S. Cl. 398/33

(57) ABSTRACT

Optical performance monitoring of a dense wave division multiplex optical communication system is immune to effects of stimulated Raman scattering. Each wavelength is modulated by an orthogonal spreading code dither signal having a predetermined modulation index. At a receiver, a portion of the aggregate optical signal is tapped and passes through a wavelength dependant optical delay filter. For each wavelength, the aggregate signal is multiplied by a synchronized copy of a respective spreading code and an autocorrelator detects the modulation power of the spreading code dither. The system can also be deployed as an optical reflectometer. For each autocorrelator, an aggregate reflected signal is multiplied by a copy of a spreading code having a respective different time delay. The distance to a reflection can be estimated from the time delay that yields the highest autocorrelation value.

### CROSS-REFERENCE TO RELATED APPLICATIONS

This is the first application filed for the present invention.

### MICROFICHE APPENDIX

Not Applicable.

### TECHNICAL FIELD

The present invention relates to optical transmission systems for optical communications and in particular to a method and system for SRS-immune optical performance monitoring in a dense wave division multiplexed (DWDM) optical transmission system.

### BACKGROUND OF THE INVENTION

Optical performance monitoring plays a vital role in supervision and monitoring of optical channels in a DWDM system by providing a means for wavelength auto-discovery and power measurement. Traditionally, signal monitoring is performed by a pilot tone technique in which a sinusoidal dither is applied to each channel. In such a system, the transmitter of each channel applies a specific sinusoidal dither of a fixed modulation depth (or “index”) that is usually proportional to the average optical power of that channel. A typical modulation index is about 1% of the channel's optical power. At downstream optical elements (e.g., optical amplifier or receiver) the aggregate of DWDM signals within the fiber is tapped and digitally processed to detect the presence of each channel and to extract the optical power of each channel.

Pilot tone techniques rely on the proportional relationship (ratio) between dither power and the optical signal power within each channel. That is, the optical signal and the added dither are proportionally amplified or attenuated as the light propagates through the transmission system. FIG. 1 illustrates three channel wavelengths, each with a respective sinusoidal dither tone applied. Each dither has a power proportional to the optical power of its respective channel. After propagating through the transmission system, the power of each dither remains proportional with the optical power of the corresponding optical signal.

The procedure of pilot tone performance monitoring is illustrated in FIG. 2. At an optical amplifier or receiver, a small portion (e.g., 2%-5%) of the optical signal is tapped out of the fiber, and converted to an electrical signal (e.g., by a PIN photodetector). At this point the electrical signal contains the total power of all channels plus a mixture of all the dithers. By using a bandpass filter, the combination of dithers is separated from the rest of the signal and injected into a digital signal processor (DSP). In the DSP, each dither is identified, and its amplitude is measured through a series of filtering and fast Fourier transform (FFT) operations. The power of the data signal in each channel can then be estimated from the amplitude of each dither and the known proportionality between dither and signal power in each channel. This information can then be used to control upstream amplifiers and transmitters (e.g., to equalize the signal strength of each of the channels).

As is well known in the art, several undesirable effects cause wavelengths of a DWDM system to interfere with each other. For example, stimulated Raman scattering (SRS) is a nonlinear phenomenon that affects parallel data traffic streams multiplexed within an optical fiber. SRS is a nonlinear scattering process which is strongly dependent on the number of wavelengths, the power levels of the involved optical signals and the fiber properties (e.g., effective core size and attenuation). If two or more optical signals at different wavelengths are injected into an optical fiber, SRS causes power to be coupled from the shorter wavelength channels to the longer wavelength channels. In the absence of SRS, all channels are attenuated relatively equally along the fiber. With SRS, each channel is attenuated along the fiber while receiving energy from all other channels with shorter wavelengths and transferring energy to all other channels with longer wavelengths (if there are any). For simplicity, fiber loss is often disregarded in SRS analysis. FIG. 3a illustrates the effect of SRS on channel power distribution. In this example, wavelength λ₁ is shorter than λ₂ which is shorter than λ₃. The three wavelengths are introduced into the fiber with equal signal power. At the output end of the fiber, the signal at λ₁ has transferred power to the other wavelengths and thus has less power. The signal at λ₂ transfers power to λ₃ and receives power from λ₁. Therefore, the signal at λ₁ loses the most power and the signal at λ₃ gains the most power. SRS power transfer (or “coupling”) between each two channels also depends on channel separation and peak Raman gain. FIG. 3b is an exemplary illustration of SRS gain distribution for an optical fiber, as a function of channel separation. In this example, the peak Raman gain coefficient is approximately 6×10⁻¹⁴ mW at a channel offset of approximately 16 THZ. SRS causes coupling in both the propagation direction and the reverse direction.

In the absence of SRS, each dither can be easily detected and can provide an accurate estimate of the optical power within its associated channel. However, in DWDM systems with channel spacing in the SRS range, both channel signal power and dither power are transferred between wavelengths. The result is that “ghost” dithers are superimposed onto other channels, as illustrated in FIG. 4, where the received signal at wavelength λ₃ now has ghost dithers from λ₁ and λ₂. In traditional pilot tone optical performance monitoring systems, when the tapped signal is converted to an electrical signal at the PIN detector, every dither, including the so-called “ghost” dithers, will be recovered as if there had been no SRS in the system. The FFT in the DSP cannot distinguish between the original dither superimposed on a channel and the “ghost” dither signals due to SRS cross-coupling from other channels. The FFT will thus add all the components of the dither signals at each dither frequency. The measured dither signal will therefore not reflect the changes in the signal strength at each channel (i.e. wavelength) as a result of SRS and thus cannot provide an accurate representation of channel signal power.

This problem becomes more serious if optical add/drop multiplexing (OADM) is performed in the system. If, at a certain amplification site in an optical network, the data signal of a specific wavelength is dropped (along with its original dither tone and the “ghost” dithers of other wavelengths), “ghosts” of the dropped signal's dither (due to SRS) will still remain in other wavelengths in the system. As a result, conventional pilot tone optical performance monitoring systems may declare that the dropped traffic still exists, based on the remaining ghost dithers. If, in addition, a new data signal (with an associated new dither tone) is added to the dropped signal's wavelength, then the conventional monitoring systems may declare that more wavelengths exist in the system than actually do.

Accordingly, a method and system for monitoring performance of optical channels and optical fibers in a dense wave division multiplexed (DWDM) optical transmission system in the presence of SRS interference, remains highly desirable.

### SUMMARY OF THE INVENTION

It is therefore an object of the present invention to provide an SRS-immune method and system for monitoring performance of optical channels and optical fibers in a dense wave division multiplexed (DWDM) optical transmission system.

Accordingly, an aspect of the present invention provides a method of monitoring optical performance of a Dense Wave Division Multiplex (DWDM) optical communication system in which a plurality of channels are multiplexed within an optical fiber. The method comprises steps of: receiving an optical signal transported through a respective one of the channels, the optical signal being modulated by a predetermined spreading code; detecting a modulation power of the predetermined spreading code; and estimating an optical power of the optical signal using the detected modulation power of the predetermined spreading code.

In some embodiments, the step of detecting a modulation power of the predetermined spreading code comprises steps of: converting an aggregate light beam composed of optical signals within all of the channels of the fiber into a corresponding electrical signal; decomposing the electrical signal into the predetermined spreading code of the optical signal; and measuring an amplitude of the decomposed electrical signal.

In some embodiments, the optical signal is received as a data signal at a downstream end of the optical fiber, and the estimated optical power of the optical signal is indicative of gain/attenuation experienced by the optical signal within the fiber.

In some embodiments, the optical signal is received as a reflected signal at an upstream end of the optical fiber, and the estimated optical power of the optical signal is indicative of reflection of the optical signal in an upstream direction of the fiber.

A further aspect of the present invention provides a dense wave division multiplex (DWDM) optical communications system comprising a plurality of system elements connected by waveguides, the system comprising: a plurality of optical transmitters, each optical transmitter comprising an optical source for generating an optical signal at a distinct wavelength, a signal modulation arrangement for modulating the optical signal with a data stream, and a dither modulation arrangement for modulating the optical signal with a dither signal having a predefined modulation index and a respective orthogonal spreading code selected from a set of orthogonal pseudorandom spreading codes having a predetermined chip duration; a plurality of optical receivers, each optical receiver for receiving an optical signal from a corresponding optical transmitter; and a monitoring arrangement comprising an optical tap for tapping a portion of the optical signals, an optical delay filter for introducing a wavelength dependant time delay to said portion of the optical signal, an optoelectronic conversion device for converting said portion of the optical signal to an electrical signal, a correlation device for recovering a respective pseudorandom code dither signal for each said distinct wavelength from said electrical signal, a measuring arrangement for measuring an amplitude of said dither signal for each wavelength, and a calculation arrangement for estimating an optical power of each channel from the amplitude of its corresponding pseudorandom code dither signal.

### BRIEF DESCRIPTION OF THE DRAWINGS

Further features and advantages of the present invention will become apparent from the following detailed description, taken in combination with the appended drawings, in which:

FIG. 1a is a schematic illustration showing a proportional relationship between dither power and optical signal power in a conventional optical transmission system;

FIG. 1b is a schematic illustration of the dither signals of FIG. 1a processed by a conventional digital signal processor (DSP) and the resulting measured signal power values;

FIG. 2 is a schematic illustration of a dither detection circuit of a conventional pilot tone optical performance monitoring system;

FIG. 3a is a schematic illustration showing an effect of stimulated Raman scattering (SRS) on power distribution of optical channels;

FIG. 3b is a graph showing typical SRS gain distribution for an optical fiber as a function of channel separation;

FIG. 4 is an exemplary illustration of the effect of SRS on sinusoidal dither signals of conventional pilot tone optical performance measurement techniques and the resulting false measured signal power values;

FIG. 5 illustrates an exemplary autocorrelation function of orthogonal pseudorandom spreading codes in accordance with an embodiment of the present invention;

FIG. 6 illustrates principal elements of an exemplary long haul DWDM optical fiber communications system in accordance with an embodiment of the present invention;

FIG. 7 is a block diagram schematically illustrating operation of the monitor of FIG. 6;

FIG. 8 illustrates characteristics of the optical delay filter of FIG. 7;

FIG. 9a is a block diagram schematically illustrating an embodiment of the present invention deployed to perform optical reflectometry; and

FIG. 9b is a graph showing an exemplary output of each autocorrelator of the embodiment of FIG. 9a.

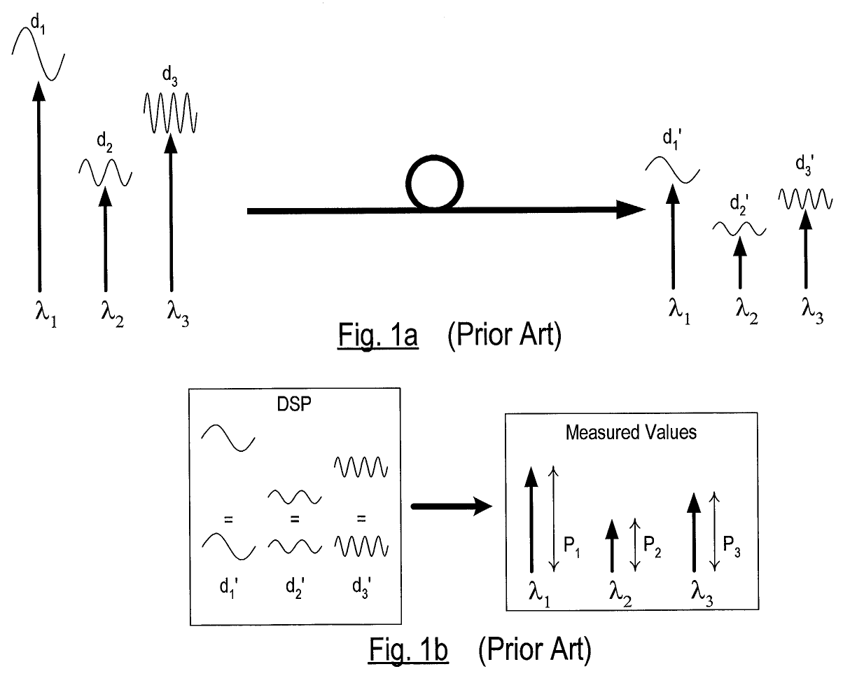

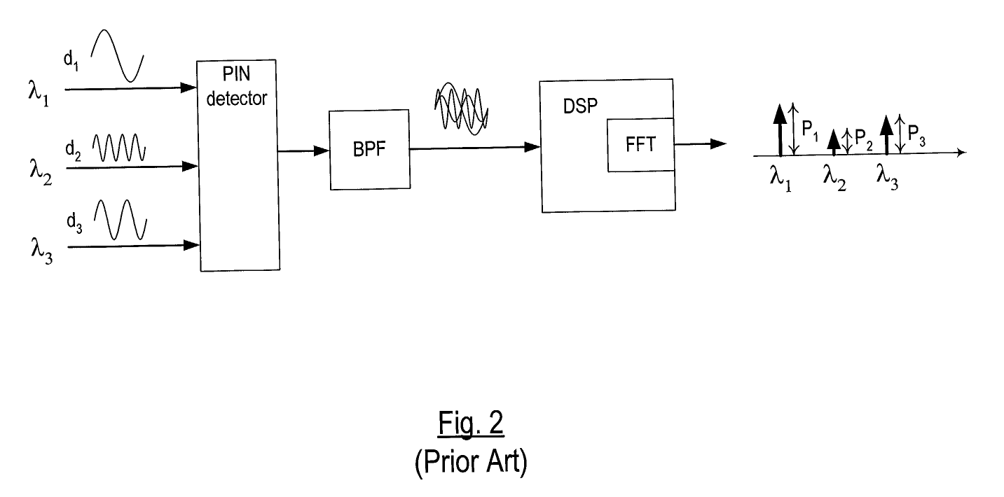

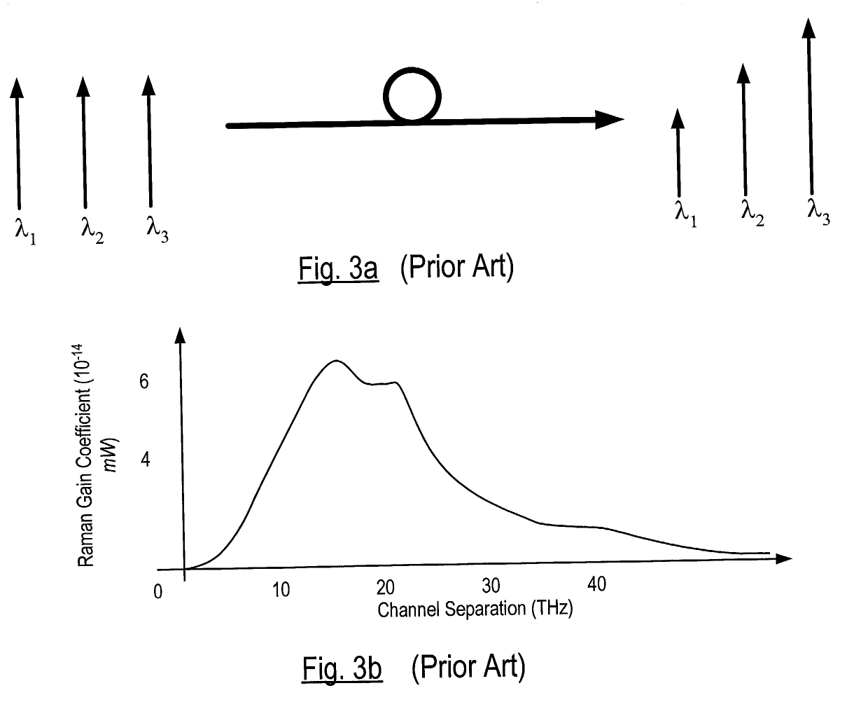

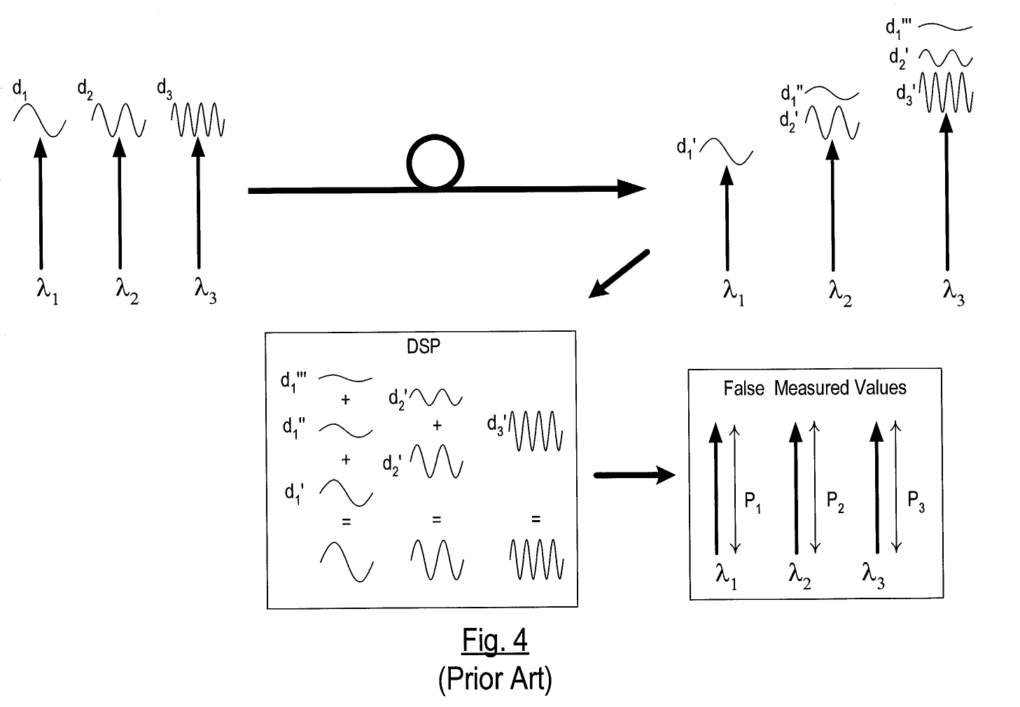

It will be noted that, throughout the appended drawings, like features are identified by like reference numerals.

### DETAILED DESCRIPTION OF THE PREFERRED EMBODIMENT

The present invention provides an SRS-immune method and system for monitoring performance of optical channels and optical fibers in a dense wave division multiplexed (DWDM) optical transmission system. The present invention exploits the autocorrelation characteristics of orthogonal spreading codes to isolate dither signals associated with each channel, from the “ghosts” of other dither signals which have been cross-coupled from neighbouring channels by SRS.

Spread spectrum technology is well known in the art and is typically used in high noise environments to improve bandwidth usage and increase the signal to noise ratio (SNR). Code division multiple access (CDMA) is a spread spectrum technology that was originally designed as a multiple access scheme for cellular wireless communication systems. This technology uses direct sequence spread spectrum (DSSS) techniques well known in the art. Orthogonal spreading codes consist of a set of chip (bit) sequences which are spectrally white but have the primary characteristic of being unique and easily distinguishable from one another.

The present invention uses orthogonal spreading codes similar to those used in CDMA, to dither each optical data wavelength (channel). The amplitude of the dither applied to each channel is a known percentage of the power of the optical data signal within that channel.

A spreading code is a sequence of “chips” valued −1 and 1 (or 0 and 1 for “non-polar”). The number of chips in one code is referred to as the length of the code. Increasing the length of the code increases the system resistance to additive noise and multiple access interference (MAI). Generally, a longer code is preferred, although at the cost of increased complexity of synchronization. As well, longer codes can provide more unique orthogonal spreading codes for uniquely addressing more data channels. Generally, spreading codes appear to be pseudorandom, so that spreading codes are often referred to as pseudorandom (PN) codes or sequences.

The ideal autocorrelation and cross-correlation properties of orthogonal spreading codes are summarized in Equation (1) where 1≦i, j≦N.

$${\int }_{0}^{T} {C}_{i} ( t ) {C}_{j} ( t + τ ) ⅆ t = \{ \begin{matrix}1 & ( i = j , & τ = 0 ) \\ 0 & ( i = j , & τ \neq 0 ) \\ 0 & ( i \neq j , & any τ )\end{matrix} \qquad ( 1 )$$

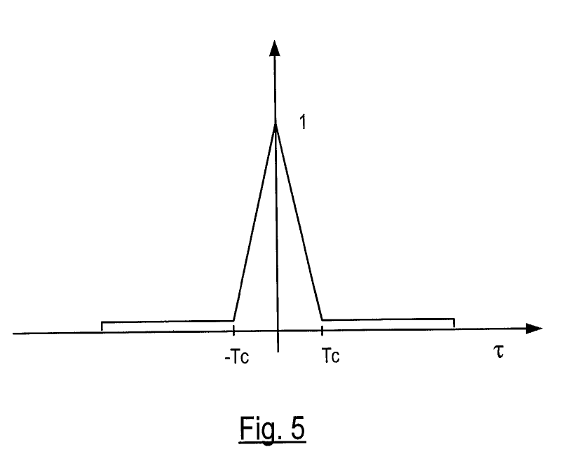

It is impossible to achieve ideal autocorrelation and cross-correlation properties in practice. FIG. 5 presents a realistic autocorrelation function for orthogonal spreading codes. The area under the curve indicates the acceptable values of the autocorrelation function for corresponding delays. As is well known in the art, orthogonal spreading codes are selected such that they have high autocorrelation when the time delay is less than about one chip duration Tc of the spreading code, and a low autocorrelation for a time delay larger than one chip duration Tc. Spreading codes are also selected to have a low cross-correlation for any value of time delay so that the probability of incorrectly recognizing a spreading code in a channel is very low.

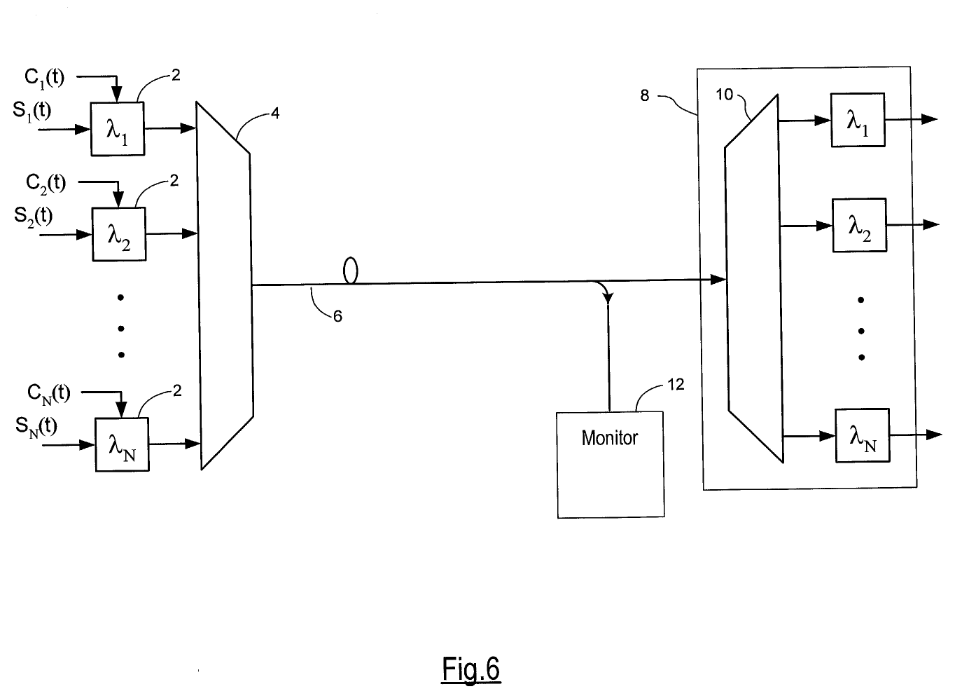

FIG. 6 illustrates principal elements of an exemplary long haul DWDM optical fiber communications system in accordance with an embodiment of the present invention. Each optical data signal Sᵢ(t) is associated with a transmitter 2 operating at a specific wavelength λᵢ, (where 1≦i≦N, and N is the number of wavelengths in the system). At each transmitter 2, the optical data signal Sᵢ(t) is dithered by having the corresponding unique spreading code Cᵢ(t) superimposed on it. Each spreading code dither is modulated according to a predetermined modulation index (for example, 1% of the power of the optical data signal). The signals from all the active data channels are multiplexed by a multiplexer 4 for transmission through an optical fiber 6 of a communication network to a receiving node 8. At the receiving node 8, the aggregate data signal is demultiplexed by a demultiplexer 10 to separate the channels. In the embodiment of FIG. 6, the optical fiber 6 is illustrated as a single span between the transmitting and receiving nodes. However, it will be appreciated that the optical fiber 6 may include multiple spans, and traverse one or more discrete network devices (e.g., optical amplifiers) intermediate the transmitting and receiving nodes. The performance monitor 12 of the present invention can be deployed anywhere along the link of the communication network. For example, a performance monitor can be associated with each optical amplifier on the link.

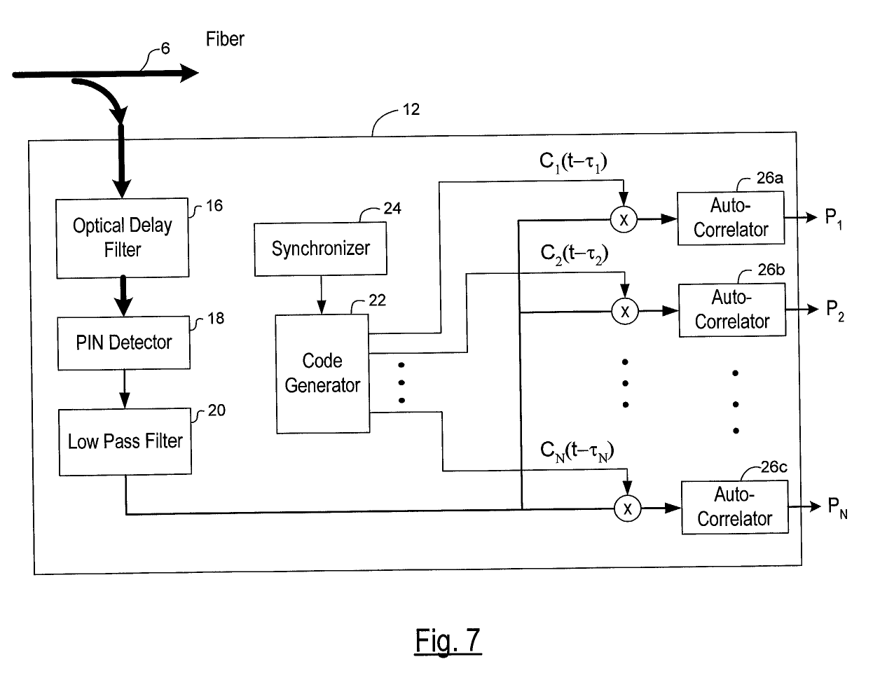

The operation of the performance monitor 12 will now be described in greater detail with reference to FIG. 7. As shown in FIG. 7, a small portion (e.g., 5%) of the aggregate optical signal (traffic plus dithers) traveling in the fiber 6 is tapped from the fiber and supplied to the performance monitor unit 12.

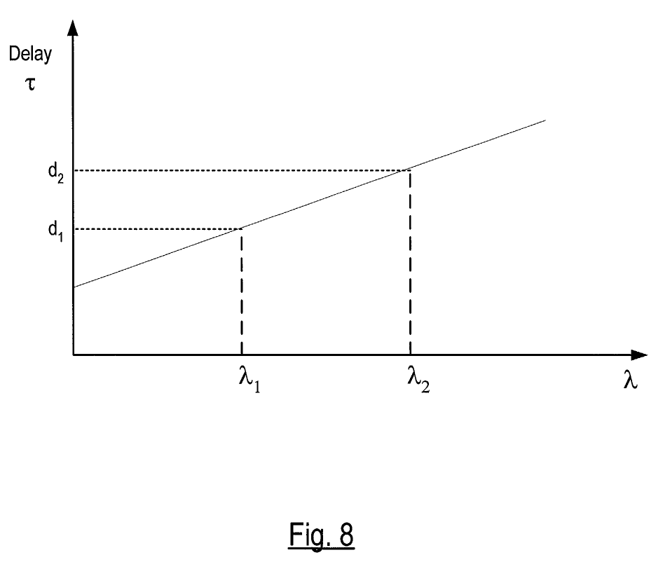

The tapped portion of the aggregate optical signal then passes through an optical delay filter 16. The optical delay filter 16 introduces a delay (or phase shift) between signals of different wavelengths, as illustrated in the graph of FIG. 8, where wavelength λ₁ has a delay of d₁ and wavelength λ₂ has a delay of d₂. Consequently, a delay is introduced between a dither of a channel, and its corresponding ghost dithers in other channels. When a dither signal and its ghost on another wavelength are separated by a delay of at least one chip duration (d₂−d₁)>Tc), the autocorrelation property of the spreading code can be used to isolate the dither from its ghosts.

The delay filter can be implemented in various known ways, such as ring resonators, or fiber Bragg grating arrays. Other optical devices with large dispersion could also be used to generate the required wavelength dependent delay for each channel. The dispersion accumulated in the fiber span could be utilized as well, if there is sufficient delay.

Referring again to FIG. 7, after the delay filter, the aggregate optical signal is converted to an aggregate electrical signal by an optical to electrical converter 18 (for example a PIN diode photo-detector). This aggregate signal is then filtered by a low pass filter 20 to remove high frequency noise.

For each channel i, the aggregate electrical signal is multiplied by a synchronized local copy of the respective spreading code Cᵢ(t−τᵢ) (where 1≦i≦N) and the multiplication result applied to an autocorrelator 26a, 26b, 26c in order to extract a respective autocorrelation value. Autocorrelators are well known in the art. Typical autocorrelators use an integrator to integrate the output of the multiplier to compute the autocorrelation value. The local copies of the spreading codes Cᵢ(t−τᵢ) are identical to the spreading codes Cᵢ(t) used by the transmitters and are produced by a spreading code generator 22.

It is important that the local copy of each spreading code Cᵢ(t−τᵢ) be synchronized with its counterpart in the received signal. To accomplish this, a synchronizer 24 is used to calculate a delay τᵢ (where 1≦i≦N), for each channel, which compensates for delays introduced by the delay filter 16 and dispersion within the fiber 6. For a given physical location and delay filter 16, the required delay for each channel will be relatively stable (i.e., deviate very little, relative to one chip duration of the spreading codes). Accordingly, the required delays for all of the channels can be measured experimentally and stored in a lookup table, if desired. This table can also be updated by periodic measurements. The local spreading code generator 22 can then use the delays stored in the lookup table to generate the appropriately delayed version of the original spreading code for each autocorrelator.

The autocorrelation value P₁, P₂, P_{N} output by each autocorrelator 26 will be proportional to the power of the data signal in the respective channel. Thus, the power of the data signal can be estimated by the autocorrelation value P₁, P₂, P_{N} and the known modulation index used at the transmitter. This information can also be used to determine the presence of each channel, which can be useful if optical add/drop multiplexers (OADM) are used in the optical fiber communications system.

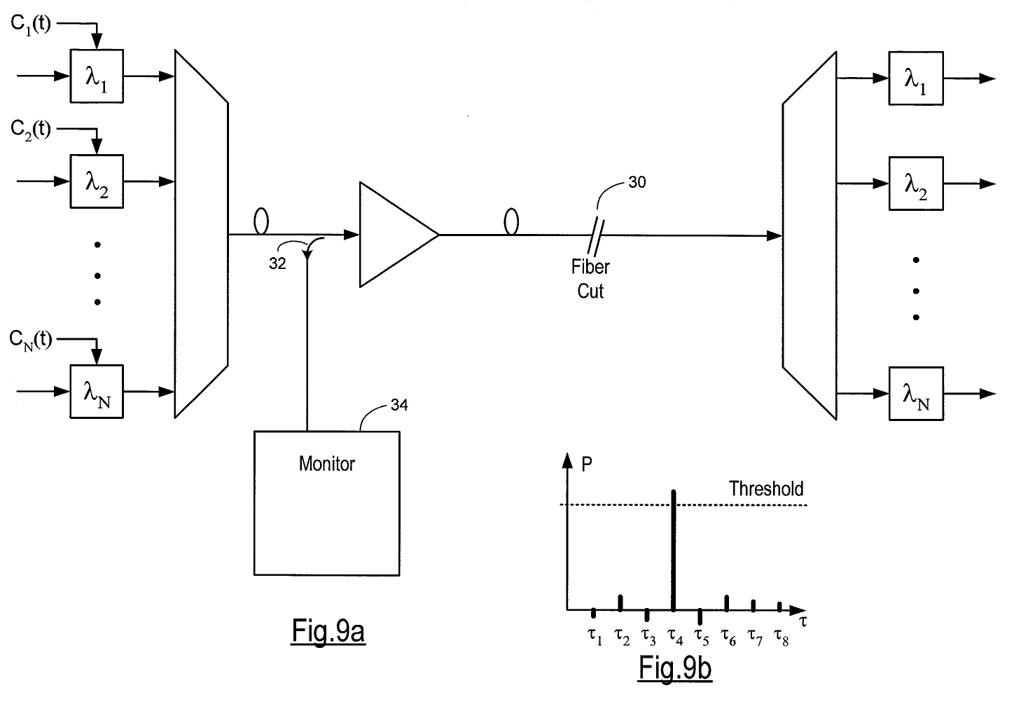

The present invention can also be deployed as an optical reflectometer, as will be described below with reference to FIG. 9a. FIG. 9a illustrates an exemplary long haul DWDM optical fiber communications system similar to the one described previously with reference to FIG. 6. Fiber cuts, deformations, dirty connections or other faults can cause signals in the optical fiber to be reflected back upstream. A fiber cut 30 is illustrated in FIG. 9a as representative of a source of signal reflections.

Therefore, instead of monitoring a transmitted data signal at a downstream end of the fiber, a performance monitor is arranged to monitor reflected data signals at an upstream end of the fiber, using a reflection tap coupler 32, in order to estimate the location of a reflection 30. The monitor 34 uses many of the same elements described previously with respect to the embodiment of FIG. 7.

Principal differences in operation of the optical reflectometer compared to the performance monitor embodiment of FIG. 7 lie in the optical delay filter, code generator, and the number of autocorrelators used. In the optical reflectometer, the optical delay filter is not needed. Only one of the spreading codes is necessary for the optical reflectometer application. The number of autocorrelators R is determined by the required accuracy and the measurement distance range. Any one of the spreading codes, superimposed on the optical signal by the transmitters, can be selected for monitoring. The code generator then provides multiple local copies of the same spreading code, each copy having respective different time delays. That is, for the signals Cᵢ(t−τᵢ) shown in FIG. 7 (but where 1≦i≦R), C₁=C₂=C₃= . . . =C_{R}, and each delay τᵢ=τ₍ᵢ₋₁₎+ΔT, where ΔT<Tc.

Thus, for each autocorrelator 26a, 26b, etc., the aggregate electrical signal is multiplied by an instance of a common spreading code, each with a different delay. The autocorrelation properties of the orthogonal spreading code ensures that only the local copy having a delay that most closely matches that of the reflected optical signal will yield a high autocorrelation value. Thus, the output of the autocorrelators can be monitored, and the autocorrelator having the highest output is selected. The location of the reflection can then easily be estimated from the time delay value τᵢ of the selected autocorrelator.

In the example of FIG. 9a, the fiber cut will cause the data signals to be reflected. Exemplary outputs of each autocorrelator are shown in the graph of FIG. 9b. The output of the autocorrelator associated with the delay τ₄ has the highest value. Therefore the delay τ₄ is the most accurate estimate of the round-trip propagation delay of the reflected light reaching the performance monitor. The reflection location can then be estimated by calculating D=[c×τ₄]/2, where: D is the distance between the monitoring point and the fiber break; τ₄ is the delay yielding the highest autocorrelation value; and c is the speed of light in the fiber.

To get accurate estimation of the reflection location, a small delay step ΔT should be used. However, the value of the delay step should be carefully chosen such that the required accuracy can be achieved with reasonable computation complexity. A smaller delay step requires more copies of the transmitted spreading code with different delays to cover the given time interval, which means that a larger number of autocorrelators R are required.

The embodiment(s) of the invention described above is(are) intended to be exemplary only. The scope of the invention is therefore intended to be limited solely by the scope of the appended claims.

We claim:

1. A method of monitoring optical performance of a Dense Wave Division Multiplex (DWDM) optical communication system in which a plurality of channels are multiplexed within an optical fiber, the method comprising steps of:
receiving an optical signal transported through a respective one of the channels, the optical signal being a modulated by a predetermined spreading code;
detecting a modulation power of the predetermined spreading code; and
estimating an optical power of the optical signal using the detected modulation power of the predetermined spreading code.

2. A method as claimed in claim 1, wherein the predetermined spreading code is unique across all of the channels multiplexed within the fiber.

3. A method as claimed in claim 2, wherein the predetermined spreading code comprises a spectrally white bit sequence having a predetermined chip duration.

4. A method as claimed in claim 3, wherein the step of receiving the optical signal comprises a step of:
introducing a predetermined time delay to the optical signal.

5. A method as claimed in claim 4, wherein the predetermined time delay is unique across all of the channels multiplexed within the fiber.

6. A method as claimed in claim 5, wherein the predetermined time delay is a function of wavelength of the optical signal.

7. A method as claimed in claim 5, wherein a difference between the respective predetermined time delays of any two channels is equivalent to at least one spreading code chip duration.

8. A method as claimed in claim 1, wherein the step of detecting a modulation power of the predetermined spreading code comprises steps of:
converting an aggregate light beam composed of optical signals within all of the channels of the fiber, into a corresponding electrical signal;
decomposing the electrical signal into the predetermined spreading code of the optical signal; and
measuring an amplitude of the decomposed electrical signal.

9. A method as claimed in claim 8, wherein the step of decomposing the electrical signal comprises a step of multiplying the electrical signal by the predetermined spreading code.

10. A method as claimed in claim 1, wherein the optical signal is received as a data signal at a downstream end of the optical fiber, and the estimated optical power of the optical signal is indicative of gain/attenuation experienced by the optical signal within the fiber.

11. A method as claimed in claim 1, wherein the optical signal is received as a reflected signal at an upstream end of the optical fiber, and the estimated optical power of the optical signal is indicative of a reflection of the optical signal in an upstream direction of the fiber.

12. A method as claimed in claim 11, further comprising a step of estimating a distance to a point of reflection.

13. A method as claimed in claim 12, wherein the step of estimating the distance comprises steps of:
converting a reflected light beam within the fiber into a corresponding electrical signal;
multiplying the electrical signal by a plurality of copies of the spreading code, each copy having a respective different time delay;
auto-correlating each multiplication result to identify the time delay that most closely matches a time delay of the spreading code in the reflected light beam; and
estimating a distance to the point of reflection based on the identified time delay.

14. An optical performance monitor adapted for monitoring optical performance of a Dense Wave Division Multiplex (DWDM) optical communication system in which a plurality of channels are multiplexed within an optical fiber, the monitor comprising:
receiving means for receiving an optical signal transported through a respective one of the channels, the optical signal being modulated by a predetermined spreading code;
detecting means for detecting a modulation power of the predetermined spreading code; and
estimating means for estimating an optical power of the optical signal using the detected modulation power of the predetermined spreading code.

15. An optical performance monitor as claimed in claim 14, wherein:
the receiving means is adapted to introduce a predetermined time delay to the optical signal.

16. An optical performance monitor as claimed in claim 15, wherein the predetermined time delay is unique across all of the channels multiplexed within the fiber.

17. An optical performance monitor as claimed in claim 16, wherein the predetermined time delay is a function of wavelength of the optical signal.

18. An optical performance monitor as claimed in claim 17, wherein a difference between the respective predetermined time delays of any two channels is equivalent to at least one spreading code chip duration.

19. An optical performance monitor as claimed in claim 14, wherein the detecting means is adapted to:
convert an aggregate light beam composed of optical signals within all of the channels of the fiber, into a corresponding electrical signal;
decompose the electrical signal into the predetermined spreading code of the optical signal; and
measure an amplitude of the decomposed electrical signal.

20. An optical performance monitor as claimed in claim 19, wherein the detecting means is adapted to decompose the electrical signal by multiplying the electrical signal by the predetermined spreading code.

21. An optical performance monitor as claimed in claim 14, wherein:
the receiving means is adapted to receive the optical signal as a data signal at a downstream end of the optical fiber; and
the estimating means is adapted to estimate gain/attenuation experienced by the optical signal within the fiber from the optical power of the optical signal.

22. An optical performance monitor as claimed in claim 14, wherein:
the receiving means is adapted to receive the optical signal as a reflected signal at an upstream end of the optical fiber; and
the estimating means is adapted to estimate the reflection of the optical signal in an upstream direction of the fiber, from the optical power of the optical.

23. An optical performance monitor as claimed in claim 22, wherein the estimating means is further adapted to estimate a distance to a point of reflection.

24. An optical performance monitor as claimed in claim 23, wherein:
the receiving means is further adapted to convert a reflected light beam within the fiber into a corresponding electrical signal;
the detecting means is further adapted to multiply the electrical signal by a plurality of copies of the spreading code, each copy having a respective different time delay; and
the estimating means is further adapted to:
auto-correlate each multiplication result to identify the time delay that most closely matches a time delay of the spreading code in the reflected light beam; and
estimate a distance to the point of reflection based on the identified time delay.
